(19) United States
(12) Patent Application Publication
(10) Pub. No.: US 2013/0037016 A1
(43) Pub. Date: Feb. 14, 2013

(54) Heated food sachet

(71) Applicant: Mark Munguia, Woodridge, IL (US)

(72) Inventor: Mark Munguia, Woodridge, IL (US)

(21) Appl. No.: 13/136,732

(22) Filed: Aug. 10, 2011

(51) Int. Cl. A47J 36/28; F24J 1/00

(52) U.S. Cl. 126/263.08

(57) ABSTRACT

A heated food sachet (10), sealed on all sides, that may be filled with one or more condiments or other edible substances (11), that contains a heat pack (12), which may be filled with a supercooled solution (13) and that contains a trigger (14). This trigger comprises two parts. First, the trigger may be one or more breakable hollow capsules (FIG. 3) or one or more air pockets (FIG. 4) that may be attached or unattached to the heat pack. Secondly, the inner part of the capsule or air pocket may contain crystals or any other substance (15) that will start the solidification process of the supercooled solution when coming into contact with each other. The heat emitted by the reaction warms the condiments or other edible substances contained in the sachet.

### CROSS-REFERENCE TO RELATED APPLICATIONS

| Patent # | Date | Inventor | Current U.S. Class |
|---|---|---|---|
| 4,379,448 | April 1983 | Kapralis, et al. | 126/263.04 |
| 4,460,546 | July 1984 | Kapralis, et al. | 422/245.1 |
| 4,532,110 | July 1985 | Kapralis, et al. | 422/245.1 |
| 4,580,547 | April 1986 | Kapralis, et al. | 126/263.03 |
| 5,305,733 | April 1994 | Walters | 126/263.01 |
| 5,662,096 | September 1997 | Walters | 126/263.03 |
| 5,915,461 | June 1999 | Tanhehco | 165/46 |
| 6,103,139 | August 2000 | Kohout | 252/70 |
| 6,178,963 | January 2001 | Baik | 126/263.03 |
| 6,878,157 | April 2005 | Walters | 607/108 |
| 7,793,665 | September 2010 | Dube, et al. | 131/337 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Supercooled solutions have been used in a variety of applications ranging from heat packs, to infusions, to wet wipes. This invention relates to the use of supercooled solutions to heat edible substances that can be easily dispensed through a food sachet.

The patented inventions using supercooled solutions, until now, have not specifically addressed potential applications with edible substances.

With reference to the trigger mechanism of most supercooled solutions designed until now, they are generally complex and relatively expensive to manufacture if they are to be used for the dispensing of small amounts of edible substances.

### BRIEF SUMMARY OF THE INVENTION

This invention comprises materials that have already been proven to be safe for carrying and dispensing edible substances. These materials may include polyethylene to contain both the edible substances and the supercooled solution. These materials are readily available and abundant requiring minimum manufacturing expenditures. This invention comprises:

1. A food sachet that may be made of a material, such as plastic or mylar, that is sealed to contain an edible substance and a heat pack.

2. A heat pack, that contains the supercooled solution and prevents any contact of the supercooled solution with the surrounding edible substance, may be made of a material such as polyethylene.

3. A trigger that, when pressure is applied, may break, crack, rip, or disfigure exposing the contained crystals or other substances capable of initiating the crystallization of the supercooled solution and that comprises either:
a. A breakable capsule, that may be made of gelatin or plastic, that cannot pierce the heat pack.
b. Or, a breakable air pocket, which may be made of soft plastic, filled with air or any gas, that is not attached to the internal wall of the heat pack.

These characteristics allow this invention to be used in a variety of portable applications where certain edible substances, such as condiments, have to be heated instantly for immediate and single use.

### BRIEF DESCRIPTION OF THE SEVERAL VIEWS OF THE DRAWINGS

FIG. 1 is a cross sectional view of a heated food sachet that contains condiment(s) or other edible substance(s), a heat pack that contains a supercooled solution, and a trigger that contains crystals or any other substance, made in accordance with the principles of the present invention.

FIG. 2 is a lateral cross sectional view of a heated food sachet that contains condiment(s) or other edible substance(s), a heat pack that contains a supercooled solution, and a trigger that contains crystals or any other substance, made in accordance with the principles of the present invention.

FIG. 3 is a cross sectional view of a trigger, as a breakable capsule, that contains crystals or any other substance, made in accordance with the principles of the present invention.

FIG. 4 is a cross sectional view of a trigger, as an air pocket, that contains crystals or any other substance, made in accordance with the principles of the present invention.

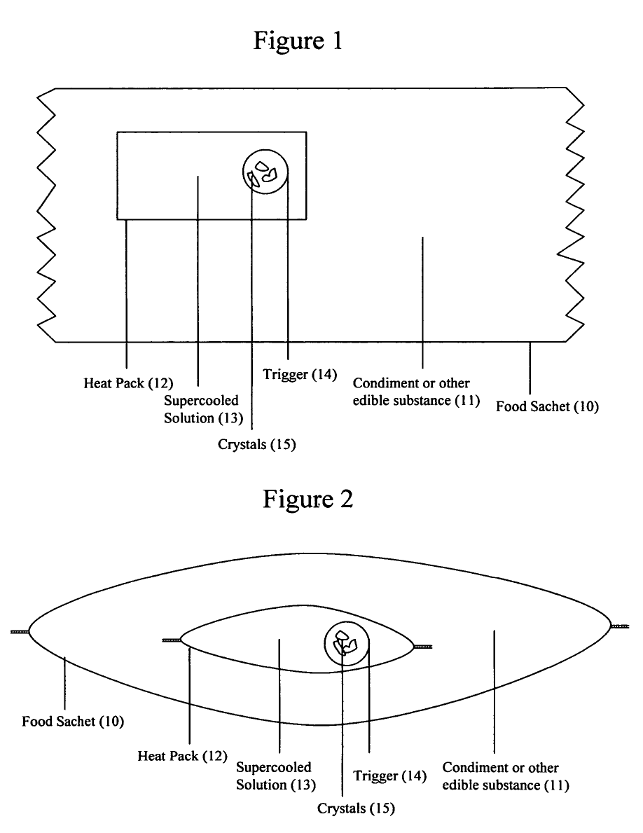

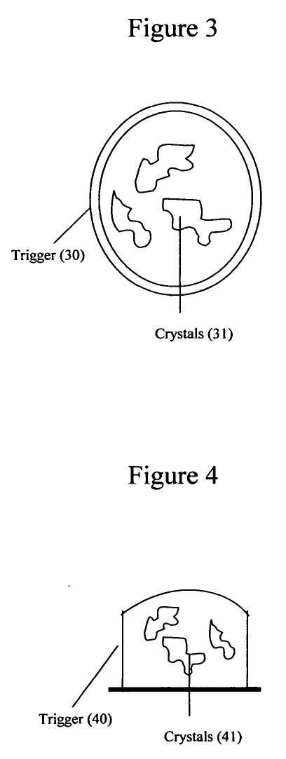

### DETAILED DESCRIPTION OF THE INVENTION

The food sachet (10) may be made of a material such as plastic, tin foil, mylar or various combinations thereof that is impervious to the contents within the sachet. The heat pack (12) may be made of a material, such as plastic, that is impervious to both the contents of the sachet (11) and the supercooled solution (13) contained within, and cannot be penetrated by the cracked or broken capsule (30) or air pocket (40). The supercooled solution (13) may be any of a variety of chemical compositions known in chemistry to give off heat as they solidify. The trigger (14), as a breakable capsule (30), may be spherical in shape, hollow, and made of a material, such as gelatin or plastic, that is impervious to the supercooled solution (13) and that will maintain the integrity of the crystals or other substances (31) enclosed within. The trigger (14), as an air pocket (40), may be made of a material that is impervious to the supercooled solution (13), such as a plastic that can be filled with air or any gas that will maintain the integrity of the crystals or other substances (41) enclosed within. The trigger (14), when pressure is applied, may break, crack, rip, or disfigure, exposing the contained crystals or other substances (15) to the supercooled solution (13) thereby starting the solidification process.

The food sachet (10) may be made of a material such as plastic, tin foil, mylar, or various combinations thereof that is impervious to the contents within the sachet. It may measure approximately 10 cm in length and approximately 4 cm in width. It may contain approximately 15 ml of one or more condiments such as popcorn oil.

The heat pack (12) may be made of a thin plastic such as a 1.5 mil Low Density Polyethylene Plastic Resin #4 that is impervious to both the contents of the sachet (11) and the supercooled solution (13) contained within. It may contain approximately 5 ml of supercooled solution. The heat pack (12) must be able to resist penetration from one or more breakable capsules (30) or air pockets (40) when they are breaking, cracking, ripping, or being disfigured, before, during and after triggering occurs. The heat pack (12) may be approximately 5 cm in length and 2.5 cm in width.

The supercooled solution (13) may be any of a variety of chemical compositions known in chemistry to give off heat as they solidify, such as sodium acetate.

The trigger (14), as a breakable capsule (30), may be spherical in shape, hollow, and made of a material, such as gelatin or plastic, that is impervious to the supercooled solution (13). It may be approximately 4-6 mm in diameter. The trigger (14), as a breakable capsule (30), when pressure is applied by the user, may break, crack, rip, or disfigure, exposing the contained crystals or other substances (31), such as dry sodium acetate crystals, to the supercooled solution (13) thereby starting the solidification process.

The trigger (14), as an air pocket (40), may be made of a material that is impervious to the supercooled solution (13), such as a soft plastic that can be filled with air or any gas that will maintain the integrity of the crystals or other substances (41) enclosed within. The trigger (14) may take the appearance of a bubble with air sealed inside. The trigger (14), as an air pocket (40), when pressure is applied by the user, may break, crack, or rip, exposing the contained crystals or other substances (41), such as dry sodium acetate crystals, to the supercooled solution (13) thereby starting the solidification process.

The ratio of supercooled solution (13) to the condiments or other edible substances (11) may be 1:5 or greater. A lower ratio produces a lower temperature of the food product, which may not be desirable. Once the exothermic reaction takes place using this ratio, the temperature of the condiment or other edible substance (11), such as popcorn oil, may rise by various degrees. In the laboratory, popcorn oil repeatedly reached a temperature of approximately 107 degrees Fahrenheit. A lower ratio produces a lower temperature of the food product.

As soon as the supercooled solution (13) begins to solidify, it is advised to shake and gently squeeze the entire sachet (10) so the heat emitting from the heat pack (12) can evenly warm the condiment, or edible substance (11). The food sachet (10) may be torn at one corner to dispense the condiment.

A thin container, that may be made of plastic or paper, can be attached to the side of the sachet and may contain popcorn salt. The thin container may be cylindrical and may be approximately 4 cm long and 3-4 mm in diameter. The top and bottom of the thin container would be sealed to maintain the integrity of its contents. The thin container can be torn at one end to pour its contents.

1. A food sachet, that can contain condiments or other edible substances which can be heated by the solidification process of a supercooled solution contained in a heat pack that comes in contact with the condiments or other edible substances and that contains a trigger mechanism to start the solidification process of the supercooled solution.

2. The food sachet of claim 1 wherein the contents are any type of edible substances that can be heated.

3. The food sachet of claim 1 which is impervious to the heat produced by the heat pack.

4. The supercooled solution of claim 1 whose ratio to the edible substances contained within the food sachet is 1:5 or larger.

5. The trigger mechanism in claim 1 wherein one or more loose crystals or other substances capable of starting the solidification process of the supercooled solution are contained in one or more capsules that, when pressure is applied, may break, crack, rip, or disfigure, exposing the contained crystals or other substances to the supercooled solution.

6. The trigger mechanism in claim 1 wherein one or more loose crystals or other substances capable of starting the solidification process of the supercooled solution are contained in one or more air pockets that, when pressure is applied, may break, crack, or rip, exposing the contained crystals or other substances to the supercooled solution.

7. The trigger mechanism in claim 1 wherein the capsule is made of a material that will not penetrate the heat pack.

8. The trigger mechanism in claim 1 wherein the air pocket is made of a material that will not penetrate the heat pack.
